(19) United States
(12) Patent Application Publication
(10) Pub. No.: US 2005/0150896 A1
(43) Pub. Date: Jul. 14, 2005

(54) Drinking flask having multiple compartments for holding and dispensing beverages and associated foods or condiments

(76) Inventor: Michael G. Morrison, Colorado Springs, CO (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 11/035,665

(22) Filed: Jan. 14, 2005

Related U.S. Application Data
(60) Provisional application No. 60/536,487, filed on Jan. 14, 2004.

(51) Int. Cl. A47J 29/00

(52) U.S. Cl. 220/912

(57) ABSTRACT

A drinking flask includes a first compartment for storing a quantity of a first liquid for drinking. A second compartment of the flask stores a first complimentary food item, and a third compartment stores a second complimentary food item. A fourth compartment includes a drink opening. A one way valve fluidly couples the first compartment and the fourth compartment when pressure is applied to the flask to dispense a portion of the quantity of the first liquid into the fourth compartment for drinking by a user through the drink opening.

The present application is based on and claims the benefit of U.S. provisional patent application Ser. No. 60/536,487, filed Jan. 14, 2004, the content of which is hereby incorporated by reference in its entirety.

### BACKGROUND OF THE INVENTION

The present invention generally pertains to the consumption of beverages, for example, alcohol. More specifically, the present invention pertains to the consumption of beverages with associated foods or condiments.

Drinking of beverages is a common social activity enjoyed by party goers and patrons of bars, nightclubs, restaurants, etc. Often times, drinking in the form of “doing shots” is a preferred activity. When drinking in the form of doing shots, one or more people consume roughly measured units of an alcoholic beverage, typically from a small measuring cup referred to as a “shot glass”. For example, shot glasses typically are used to measure out between one half fluid ounce and one full fluid ounce of a desired beverage. Other units of measuring the quantity of alcoholic beverage in a shot can also be used. For example, a shot is sometimes defined as two-thirds of a British jigger (one jigger=1.5 fluid ounce), which is again one fluid ounce. As another example, a shot has been defined as one eighth of a gill (one gill=one half cup) from the British Imperial or United States Customary System, which is again one half of a fluid ounce. Regardless of the quantity of alcohol used in a shot, the consumption of alcohol should be done responsibly and in moderation. For instance, alcohol should not be consumed by minors or in any situation where the activity is illegal. Further, when consuming alcohol in any quantity, motor vehicles should not be operated and/or a designated driver should be identified to ensure the safety of all. For health reasons, some individuals should not consume any alcohol.

When doing shots in a private residence, outside, or in other locations in which a supply of shot glasses is not readily available, this activity can require additional planning as the shot glasses must be procured, brought to the location, and accounted for during the social activity. Having to plan such an activity is often considered by participants to adversely effect the spontaneity of the activity, thus potentially rendering it less enjoyable. Further, the shot glass is occasionally carried off by a participating shot drinker. Whether the shot glass is carried off intentionally or unintentionally, removal of the shot glass from the vicinity of the beverage to be consumed can hamper the enjoyment of others who have not yet had an opportunity to partake in the activity.

One particular beverage which is frequently consumed in social settings is tequila. Tequila is a Mexican liquor distilled from the fermented juices obtained from the hearts of blue agave plants grown in the Tequila Region. The liquor gets its name from the town of Tequila located in the state of Jalisco where production started more than 200 years ago. As memorialized in well known songs (e.g., the song entitled “Jose Cuervo” by Shelley West) and movies which describe this common social activity, tequila is often consumed in the form of doing shots with a little salt and lime. For example, salt is typically placed on the consuming individual's hand. Just prior to drinking the shot of tequila, the individual tastes the salt on his or her hand. Then, just after drinking the shot of tequila, the individual sucks the juice from a slice of lime. The combination of the salt, tequila and lime is thought by some to make the flavor of the tequila even more enjoyable than when consumed alone. For others, the act of drinking the tequila with these two “condiments” is an enjoyable experience due to the long standing tradition of the activity. The term “condiments” in this context refers to consumable foods (such as citrus fruits, e.g., lime), spices (e.g., salt) and other consumable items which are commonly consumed in conjunction with the drinking of a particular beverage (e.g., tequila).

The need to supply tequila, a shot glass, salt and limes to engage in this common pastime requires even more planning than when consuming other beverages in a shot glass. The person or persons planning the activity will likely need to bring multiple containers to store these differing, but complimentary, items. As mentioned previously, the need for such planning can adversely impact the enjoyment of the activity for those doing the planning. Conversely though, the person or persons who provide such planning sometimes gain the appreciation of those who enjoy the activity, but who did not participate in the planning. Those who may chose to plan this activity must balance the considerations of the inconvenience of bringing and keeping track of these items (tequila, shot glass, salt and lime) , against the reward of seeing their friends enjoy themselves and the gratitude displayed by their friend. A convenient method of bringing and coordinating these items to a desired location would therefore be a beneficial improvement.

The present invention provides solutions to one or more of the above-described problems and/or provides other advantages over the prior art.

### SUMMARY OF THE INVENTION

A drinking flask includes a first compartment for storing a quantity of a first liquid for drinking. A second compartment of the flask stores a first complimentary food item, and a third compartment stores a second complimentary food item. A fourth compartment includes a drink opening. A one way valve fluidly couples the first compartment and the fourth compartment when pressure is applied to the flask to dispense a portion of the quantity of the first liquid into the fourth compartment for drinking by a user through the drink opening. The complimentary food items which can be stored in the second and third compartments include, in one embodiment salt and either lime/lemon juice or lime/lemon slices.

Other features and benefits that characterize embodiments of the present invention will be apparent upon reading the following detailed description and review of the associated drawings.

### BRIEF DESCRIPTION OF THE DRAWINGS

FIGS. 1 and 2 illustrate embodiments of a drinking flask in accordance with the invention.

FIGS. 3 through 6 illustrate alternate embodiments of compartments of the drinking flask shown in FIGS. 1 and 2.

### DETAILED DESCRIPTION OF ILLUSTRATIVE EMBODIMENTS

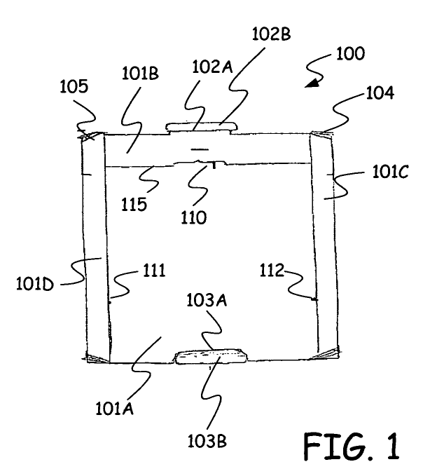

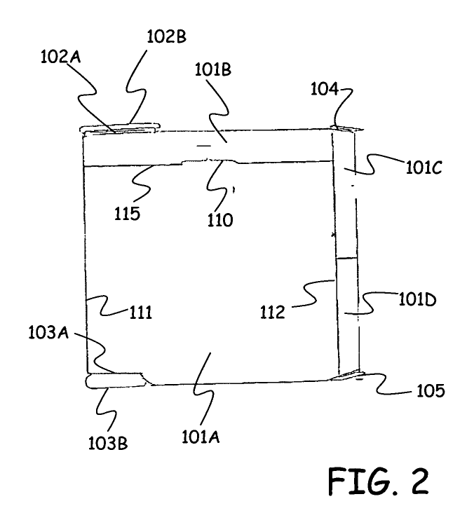

The present invention relates to a flask that is specific to the consumption of liquids in measured volumes (for example a volume of ½ ounce at a time), with additional compartments comprised with the intended use (and corresponding supporting configurations) of storing and dispensing liquids and/or other consumable items that are of different flavors than that which are stored and dispensed in the other main compartment(s). For example, in some embodiments a first compartment can hold a first liquid of a first flavor (e.g., tequila) while a second compartment holds a second liquid having a second flavor (e.g., lime or lemon juice). Third and/or forth compartments store and dispense these or other liquids or solids (e.g., salt). Numerous other embodiments are contemplated, including two illustrated in FIGS. 1 and 2.

Referring now to FIGS. 1 and 2, shown are two example embodiments of a drinking flask or apparatus 100. In these embodiments, flask 100 includes four separate compartments, numbered 101A through 101D. Compartment 101A is a main storage compartment, which in one embodiment holds approximately 8 ounces of a first desired fluid. Storage compartment 101A can hold other quantities of the first fluid in other embodiments. Compartments 101C and 101D are positioned either on opposites sides of main storage compartment 101A, or on the same side of main storage compartment 101A. A fourth compartment 101B, also referred to as a dispensing compartment, is in these embodiments shown positioned on top of main storage compartment 101A, though other positions can be used as well.

Main storage compartment 101A includes, in some embodiments, a fill opening 103A through which the first fluid can be filled or refilled into compartment 101A. Fill opening 103A is sealable with a lid or cap 103B. In some embodiments, fill opening 103A is a threaded or screw opening, and lid 103B is a threaded or screw top, which together seal compartment 101A. Opening 103A and lid 103B are shown positioned at a bottom of flask 100, but this need not be the case in all embodiments. Opening 103A and lid 103B can be placed at various locations along the bottom of the flask, or alternatively elsewhere on the flask.

In between compartments 101A and 101B is a one way valve 110 which allows fluid to flow from compartment 101A to compartment 101B when pressure is applied to compartment 101A (or alternatively elsewhere on the flask), but substantially not in the opposite direction under normal use. One way valve 110 can be a nipple type valve, a ball type valve, or other types of one way valves. One way valve 110 can also be a type of valve which would in fact allow fluid passage in either direction depending upon the pressure differential between compartments, but which for practical purposes only allows fluid flow from compartment 101A to 101B because the size and placement of compartment 101A result in higher pressures being applied to this compartment. A nipple type valve is one such example. In the illustrated embodiment, valve 110 is positioned in the center of a dividing wall 115 between chambers 101A and 101B. Dispensing compartment 101B includes a lid 102B which seals an opening 102A. Dispensing compartment 101B can, in some embodiments, only be filled from main compartment 101A once lid or cap 102B is removed, screwed off or otherwise opened to allow access to dispensing compartment 101B through opening 102A, and compartment 101A is squeezed. This allows pressure equalization of the fluid compartments, and thus fluid to flow under application of pressure.

In some embodiments, compartment 101B holds approximately ½ ounce or other predetermined fixed or measured quantities of fluid from compartment 101A. The screw-top or other opening for compartment 101B is able to be located at various locations along the top of the flask as illustrated in FIGS. 1 and 2. In some embodiments, opening 102A is positioned in the center of flask 100 and compartments 101C and 101D are positioned on opposite sides of main storage compartment 101A as shown in FIG. 1. In other embodiments, opening 102A is positioned to one side of the flask, and compartments 101C and 101D are positioned on a same side of compartment 101A. In the embodiment shown in FIG. 1, compartments 101C and 101D are both single compartments equaling in height that of the total height of the flask 101. In the embodiment shown in FIG. 2, compartments 101C and 101D together equal the total height of the flask. Other sizes and placements of compartments 101C and 101D are also possible. Compartments 101C & 101D are compartments onto themselves, separated from compartments 101A and 101B by interior walls 111 and/or 112. The compartments can be equal in size, or of varying size. Compartments 101C and 101D can also be positioned on either side (right or left) of main compartment 101A and dispensing compartment 101B.

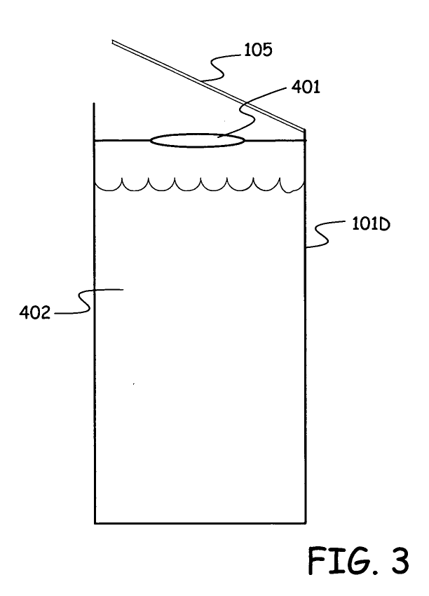

Both of compartments 101C and 101D include lids, caps or other closing mechanisms (104 and 105, respectively). Examples of each of these compartments is shown in FIGS. 3 through 6, but these compartments are not limited to the particular design or configuration shown. In some embodiments, the lids 104 and 105 of these compartments are “flip-top” closings as is shown diagrammatically in FIGS. 3 through 6. Compartment 101D can have a flip-top 105 with a small round opening 401 positioned underneath the flip top 105 as is shown in FIG. 3. In some embodiments, the opening 401 is big enough to fill with juice 402 from a lime/lemon juice container, but small enough so that liquid from container 101D can be controlled to exit in small amounts when flask is tilted.

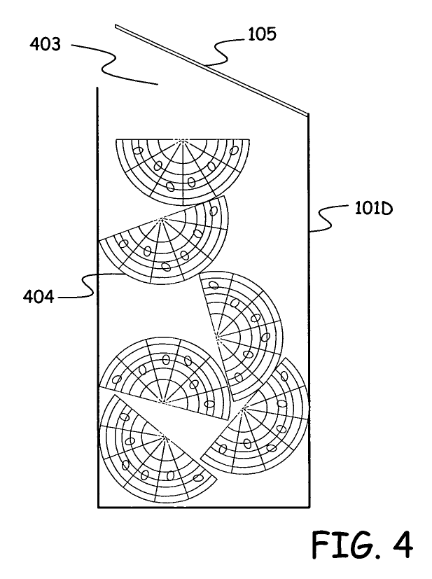

In another embodiment illustrated diagrammatically in FIG. 4, compartment 101D can have a flip top 105 with a larger opening 403 which is big enough to allow placement of freshly cut lime/lemon slices 404 into the compartment. While use of real lime/lemon slices instead of lime/lemon juice takes additional space and requires that the slices be relatively freshly cut, some individuals may prefer the actual citrus fruit to just the juice of the fruit. The alternative embodiments shown in FIGS. 3 and 4 accommodate either preference.

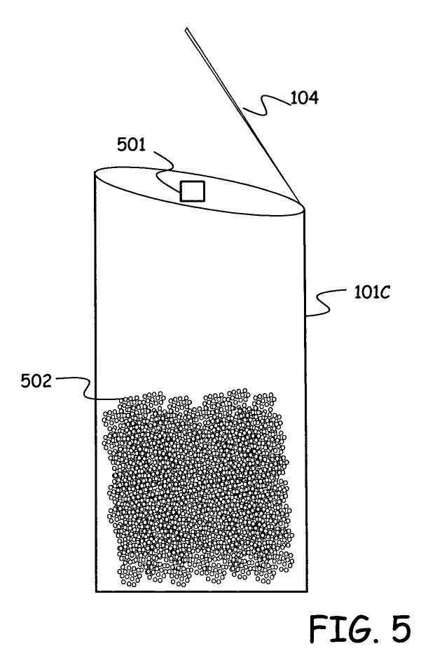

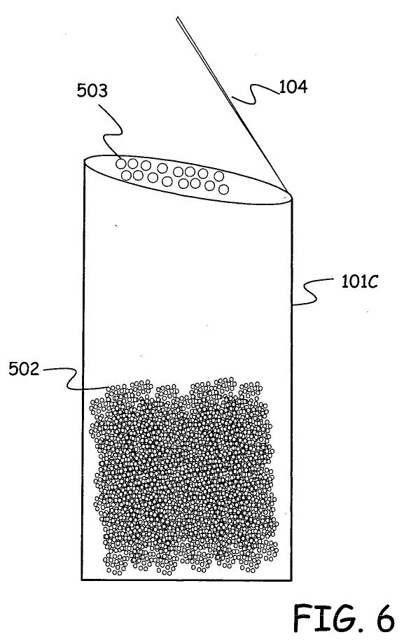

Compartment 101C can also have a number of different configurations to facilitate the filling of, and dispensing of salt from, the compartment. Referring now to FIG. 5, shown diagrammatically is an embodiment having the flip top 104 with an opening 501 (for example a square opening) underneath that will allow salt 502 (in the form of salt granules) to be filled and emptied in small quantities. FIG. 6 illustrates a similar embodiment, but instead has a perforated portion 503 for dispensing salt 502 in the same manner as a common table salt shaker. Perforated portion 503 can be removable to allow salt in container 101C to be replenished.

The embodiments of the present invention are particularly well suited for the consumption of tequila with salt and lime, although other beverages and complimentary food items can be used as well or instead. When an individual wishes to consume a shot of tequila, he or she can open the lid 104 of compartment 101C and dispense salt onto his or her hand. The lid 102B of dispensing compartment 101B can then be removed and a desired quantity of tequila can be transferred from main storage compartment 101A, through valve 110, into the dispensing compartment by applying appropriate pressure. The salt can then be tasted, and the tequila drank from compartment 101B through opening 102A. Then, either a lime slice or lime juice from compartment 101D can be tasted. This method provides a unique and enjoyable experience for the individual due in part to the novelty of the flask 100 relative to conventional tequila consuming techniques. The flask of the present invention also makes it easier to bring the desired ingredients, particularly when lime juice is used. Further, when lime juice is used, the tequila, salt and lime juice can be prepackaged by a tequila manufacturer and sold as a novelty item in liquor stores.

Although the present invention has been described with reference to particular embodiments, workers skilled in the art will recognize that changes may be made in form and detail without departing from the spirit and scope of the invention. For example, while embodiments have been described with reference to tequila, salt and lime, the present invention is not limited to these particular liquids, foods or condiments. Further, terms and phrases such as “complimentary food item” are intended to cover complementary spices such as salt, as well as complimentary fruits or fruit juices such as slices of lime or lime juice.

1. A drinking flask comprising:
a first compartment for storing a quantity of a first liquid for drinking;
a second compartment for storing a first complimentary food item; and
a third compartment for storing a second complimentary food item.

2. The drinking flask of claim 1, and further comprising:
a fourth compartment;
a drink opening in the fourth compartment; and
a one way valve fluidly coupling the first compartment and the fourth compartment when pressure is applied to the flask to dispense a portion of the quantity of the first liquid into the fourth compartment for drinking by a user through the drink opening, the one way valve maintaining fluid separation between the first and fourth compartments when the pressure is not applied to the flask.

3. The drinking flask of claim 2, and further comprising:
a fill opening in the first compartment for filling the first compartment with the first liquid; and
a first lid coupleable to the fill opening to seal the first compartment.

4. The drinking flask of claim 2, wherein the second and third compartments have lids which can be opened and reclosed.

5. The drinking flask of claim 4, wherein the second compartment has a perforated portion for the dispensing of salt from the second compartment when the lid of the second compartment is opened.

6. The drinking flask of claim 4, wherein the second compartment has an opening through which salt can be inserted or dispensed when the lid of the second compartment is opened.

7. The drinking flask of claim 4, wherein the third compartment has an opening which allows lime slices to be placed in or removed from the third compartment when the lid of the third compartment is opened.

8. The drinking flask of claim 4, wherein the third compartment has an opening which allows lime juice to be poured in or dispensed from the third compartment when the lid of the third compartment is opened.

9. The drinking flask of claim 4, wherein the lids of the second and third compartments are flip top lids.

10. The drinking flask of claim 4, wherein the fourth compartment is positioned above the first compartment, and wherein the second and third compartments are positioned on different sides of the first compartment.

11. The drinking flask of claim 4, wherein the fourth compartment is positioned above the first compartment, and wherein the second and third compartments are positioned on a same side of the first compartment.

12. The drinking flask of claim 2, wherein the first, second, third and fourth compartments are integrally formed from plastic.

13. A drinking flask comprising:
a first compartment storing a first quantity of tequila;
a second compartment storing a first quantity of dispensable salt granules;
a second compartment lid which can be opened and closed;
a dispensing portion forming part of the second compartment and allowing some of the first quantity of dispensable salt granules to be dispensed when the second compartment lid is open;
a third compartment configured to store lime slices or lime juice;
a third compartment lid which can be opened and closed;
a fourth compartment;
a drink opening in the fourth compartment;
a fourth compartment lid which can be opened and closed to unseal and seal the drink opening; and
a one way valve fluidly coupling the first compartment and the fourth compartment when pressure is applied to the flask to dispense a portion of the first quantity of tequila into the fourth compartment for drinking by a user through the drink opening, the one way valve maintaining fluid separation between the first and fourth compartments when the pressure is not applied to the flask.

14. The drinking flask of claim 13, wherein the fourth compartment is positioned above the first compartment, and wherein the second and third compartments are positioned on different sides of the first compartment.

15. The drinking flask of claim 11, wherein the fourth compartment is positioned above the first compartment, and wherein the second and third compartments are positioned on a same side of the first compartment.

17. A method of dispensing tequila, salt and lime from a flask apparatus for consumption by a user, the method comprising:
opening a lid of a salt containing compartment of the flask apparatus and dispensing a portion of the salt onto the hand of the user;
opening a lid of a dispensing compartment of the flask apparatus;
applying pressure to a tequila storage compartment of the flask apparatus to transfer a quantity of tequila from the tequila storage compartment, through a one way valve, into the dispensing compartment of the flask apparatus;
tasting the salt from the hand of the user;
drinking the quantity of tequila from the dispensing compartment of the flask; and
tasting a lime slice or lime juice from a lime compartment of the flask apparatus.
